(19) United States
(12) Patent Application Publication
(10) Pub. No.: US 2012/0000565 A1
(43) Pub. Date: Jan. 5, 2012

(54) Barrel Form and Manufacturing Process for Same

(75) Inventors: Ken Bolam, Apex, NC (US); Bryan Scheuhing, Waxhaw, NC (US); M. Shane Price, Durham, NC (US)

(73) Assignee: Goody Products, Inc., Atlanta, GA (US)

(21) Appl. No.: 13/101,879

(22) Filed: May 5, 2011

Related U.S. Application Data
(60) Provisional application No. 61/331,592, filed on May 5, 2010.
(60) Provisional application No. 61/345,705, filed on May 18, 2010.

(51) Int. Cl. F16L 9/00; B21C 37/06

(52) U.S. Cl. 138/156; 72/368

(57) ABSTRACT

A process of making an adjustable diameter barrel form includes the steps of providing a sheet formed of metal and folding the sheet along a widthwise bend. Pressure is applied to the sheet along the bend within a rolling device. The sheet is rolled within the rolling device over its length gradually moving the bend from one lengthwise end to the other lengthwise end while applying the pressure. The pressure is removed to release the sheet so that the sheet can roll up in a lengthwise direction into a coil. The rolling device can include a pair of rollers, an arbor, and a mandrel on the arbor. The rolling device can include a base plate, a press plate, and a mandrel between the plates.

### RELATED APPLICATION DATA

This patent is related to and claims priority benefit of prior filed U.S. provisional application Ser. Nos. 61/331,592 filed on May 5, 2010 and 61/345,705 filed on May 18, 2010, each entitled “Adjustable-Diameter Barrel and Manufacturing Process.” The entire contents of these prior filed provisional applications are hereby incorporated by reference herein.

### BACKGROUND

1. Field of the Disclosure

The present invention is generally directed to spiraled or coiled metal parts and processes and methods for forming same, and more particularly to a barrel form and a process for manufacturing same.

2. Description of Related Art

Many implements are known to employ cylindrical barrels of a fixed-diameter that are made from a heat-conductive material such as sheet metal. In one example, hairstyling products, such as curling irons, rollers, curlers, and the like, utilize such metal barrels. Other products are also known to employ cylindrical metal barrels of this type. It is also known in the art to produce spiraled or coiled sheet metal products that are capable of radial adjustability, i.e., having an adjustable-diameter characteristic.

However, known techniques that can be used to form spiraled or coiled sheet metal objects are prohibitively expensive for many products and/or require time-consuming processes from start to finish. Some products would simply become too costly to manufacture if fabricated with a coiled or spiraled sheet metal part that was produced by conventional techniques. In one known process, a roll form machine is used to shape a strip of annealed sheet metal into a spiraled or coiled, i.e., a rolled shape over its length. A series of rollers are provided to progressively shape the strip from a flat sheet to the rolled shape. The strip is run along the progressive rollers and a force is applied along a single tangent point between the rollers and a mandrel to gradually shape the annealed strip into the barrel form. In the known roll forming processes, once the annealed stock material is shaped to the barrel form and the stock is cut to length or into multiple parts, the barrel or barrels are subsequently heat-treated to achieve a desired hard temper and then polished to achieve the desired surface finish characteristics.

Known roll forming processes require highly specialized machinery and specific tooling adapted to fit the machinery and to make the desired roll form shape. Each roller set has a different profile and thus must be separately manufactured, tooled, or machined. Thus, the roll forming machinery and tools are very expensive. Additionally, the subsequent heat-treating, i.e., hardening, and polishing operations are also very expensive, and can be particularly difficult to perform on a rolled or coiled metal form. Heat-treating the rolled form requires a furnace, fuel for the furnace, and significant time for the process to achieve a desired hard temper. Once heat-treated, the rolled form would then have to be cleaned and refinished in another secondary operation in order to remove slag produced during the heat-treating process. This secondary procedure further increases the manufacturing time and cost of the overall process to producing the roll formed barrel shape.

If attempting to use conventional rolling or roll forming techniques to fabricate a small-diameter barrel from a hardened material, i.e., negating the need for the secondary heat-treating and polishing steps, the roll forming machinery typically cannot apply sufficient force to bend or form the hardened material. The rollers and mandrel typically cannot achieve sufficient force or loads across the distance or length required along the progression of rollers without deforming. This is because of the high stresses or forces required to roll hardened sheet metal.

### SUMMARY

In one example according to the teachings of the present invention, a process of making an adjustable diameter barrel form includes providing a sheet formed of metal. The sheet is positioned with one side against two rollers that are spaced apart and the other side facing a mandrel of an arbor plate. The sheet is folded by moving the mandrel of the arbor plate into contact with the sheet between the two rollers. The two rollers are rotated so as to bend the sheet over substantially the entire length of the sheet. The arbor plate and mandrel are retracted to release the sheet so that the sheet can roll into a coil in a lengthwise direction.

In one example, the step of providing can include providing a heat-treated metal sheet.

In one example, the process can further include the step of adjusting a spacing between the two rollers to achieve a desired roll form diameter of the coil.

In one example, the step of rotating can include rotating the two rollers in unison.

In one example, the step of rotating can include rotating the two rollers in one direction until one lengthwise end of the sheet nears or reaches the mandrel and then rotating the two rollers in the opposite direction until the other lengthwise end of the sheet nears or reaches the mandrel.

In one example, one or more of the steps of positioning, folding, rotating, and retracting can be performed manually.

In one example, one or more of the steps of positioning, folding, rotating, and retracting can be performed in an automated machine.

In one example, the step of positioning can include positioning the sheet against two rollers that can be formed of, or that can have an outer surface formed of, an elastomeric material that can inhibit marring surfaces of the sheet but also increase friction between the outer surfaces of the two rollers and the sheet.

In one example, the process can further include the step of locating a pressure pad opposing the arbor and mandrel between the two rollers.

In one example according to the teachings of the present invention, a process of making an adjustable diameter barrel form includes the step of providing a sheet formed of metal. The sheet is positioned with one side of the sheet flat against a base plate. A mandrel is placed across a width of the sheet and the sheet is folded over the mandrel, exposing a portion of the one side. Pressure is applied against the exposed portion of the one side along the fold using a press plate forcing the mandrel and sheet toward the base plate. The press plate is moved parallel to the base plate, rolling the mandrel from one lengthwise end of the sheet to the other. The press plate and mandrel are removed to release the sheet so that the sheet can roll into a coil in a lengthwise direction.

In one example, the step of moving can include manually moving the press plate.

In one example, the step of moving can include moving the press plate in one direction until one lengthwise end of the sheet nears or reaches the mandrel and moving the press plate until the other lengthwise end of the sheet nears or reaches the mandrel.

In one example, the step of moving can include moving the press plate in one direction until one lengthwise end of the sheet nears or reaches the mandrel, flipping the mandrel and sheet over, and moving the press plate in the same one direction until the other lengthwise end of the sheet nears or reaches the mandrel.

In one example, one or more of the steps of positioning, placing, folding, applying, moving, and removing can be performed manually.

In one example, one or more of the steps of positioning, placing, folding, applying, moving, and removing can be performed in an automated machine.

In one example, the step of applying pressure can include using one side of the press plate having an outer surface formed of an elastomeric material that inhibits marring surfaces of the sheet but increases friction between the outer surface of the press plate and the sheet.

In one example according to the teachings of the present invention, a process of making an adjustable diameter barrel form includes providing a sheet formed of metal and folding the sheet along a widthwise bend. Pressure is applied to the sheet along the bend within a rolling device. The sheet is rolled within the rolling device over its length gradually moving the bend from one lengthwise end to the other lengthwise end while the pressure is applied. The pressure is removed to release the sheet so that the sheet can then roll up in a lengthwise direction into a coil.

In one example, the step of folding can include folding the sheet through contact with a mandrel.

In one example, the step of folding can include placing the sheet against a spaced apart pair of rollers and moving a mandrel of an arbor plate against the sheet and between the pair of rollers. The step of applying pressure can be conducted between the rollers. The step of rolling can include rotating the pair of rollers in unison to move the bend.

In one example, the step of folding can include placing the sheet against a base plate and folding the sheet over a mandrel. The step of applying pressure can be conducted forcing a press plate against the mandrel and base plate. The step of rolling can include moving the press plate parallel to the base plate to roll the mandrel to move the bend.

In one example according to the teachings of the present invention, a barrel form product can be produced by any one of the above-noted process. The barrel form product can be an adjustable diameter barrel form. The barrel form product can alternatively be a fixed diameter barrel form.

### BRIEF DESCRIPTION OF THE DRAWINGS

Objects, features, and advantages of the present invention will become apparent upon reading the following description in conjunction with the drawing figures, in which:

FIG. 1 shows a side view of a flat metal sheet and manual barrel forming equipment at a preliminary stage of one example of a process for manufacturing a barrel form from the metal sheet.

FIG. 2 shows the metal sheet of FIG. 1 after being folded during a stage of the process.

FIG. 3 shows the metal sheet of FIG. 2 as one half of the metal sheet is rolled.

FIG. 4 shows the metal sheet of FIG. 3 after the one half has been rolled.

FIG. 5 shows the metal sheet after being reversed and prior to rolling the other half of the sheet.

FIG. 6 shows the metal sheet of FIG. 5 as the other half of the metal sheet is being rolled.

FIG. 7 shows the metal sheet in a barrel form after completion of the process of FIGS. 2-6.

FIG. 8 shows a perspective view of one end of the barrel form metal sheet shown in FIG. 7.

FIG. 9 shows a side schematic view of a flat metal sheet and barrel forming machine or device at a preliminary stage of another example of a process for manufacturing a barrel form from the metal sheet.

FIG. 10 shows the metal sheet of FIG. 9 during a bending stage of the process.

FIG. 11 shows the metal sheet of FIG. 10 after the bending stage of the process.

FIG. 12 shows the metal sheet of FIG. 11 during a rolling stage of the process while rolling of one half of the metal sheet.

FIG. 13 shows the metal sheet of FIG. 12 during a rolling stage of the process while rolling of the other half of the metal sheet.

FIG. 14 shows the metal sheet in barrel form after completion of the barrel forming process.

FIG. 15 shows an alternate example of the barrel forming machine substantially similar to that shown in FIG. 11.

FIG. 16 shows the barrel forming machine after adjustment of the roller spacing.

FIG. 17 shows a side view of a flat metal sheet and barrel forming machine at a preliminary stage of another example of a process for manufacturing a barrel form from the metal sheet.

FIG. 18 shows the metal sheet of FIG. 17 after a bending stage of the process.

FIG. 19 shows the metal sheet during a rolling stage of the process while rolling one half of the metal sheet.

FIG. 20 shows the metal sheet during a rolling stage of the process while rolling the other half of the metal sheet.

FIG. 21 shows the barrel form metal sheet after completion of the barrel forming process and being ejected from the machine.

### DETAILED DESCRIPTION OF THE DISCLOSURE

In view of the foregoing problems, there exists a need for a simpler, less expensive process to fabricate spiraled or coiled barrel forms, both of the fixed-diameter and adjustable-diameter variety. The processes and barrel forms disclosed herein are well suited for relatively low cost hairstyling implements such as curling irons, rollers, curlers, and other hairstyling products.

The disclosed adjustable-diameter barrel form and manufacturing processes solve or improve upon one or more of the above-noted and/or other problems and disadvantages with prior known roll forms and processes. The disclosed processes can be utilized to make adjustable-diameter barrels or fixed-diameter barrels, if desired. The disclosed processes can be used to make adjustable-diameter barrels for use in hairstyling implements such as curling irons, rollers, curlers, and round barrel brushes or in other products. Alternatively, the disclosed processes can be used to make fixed-diameter barrels for use with other implements or with non-adjustable diameter hairstyling products. The disclosed adjustable-diameter barrels are radially adjustable to larger or smaller diameters because the ends of the coil or barrel form are not joined, but instead overlap one another. As used herein, the term “barrel” can mean any coil or spiraled sheet of material, whether having a fixed diameter or an adjustable diameter that is formed for use in a final product, whether it is a hairstyling implement or other type of product. Thus, the disclosed barrels are open ended cylindrical tubes of material having either a fixed or adjustable diameter.

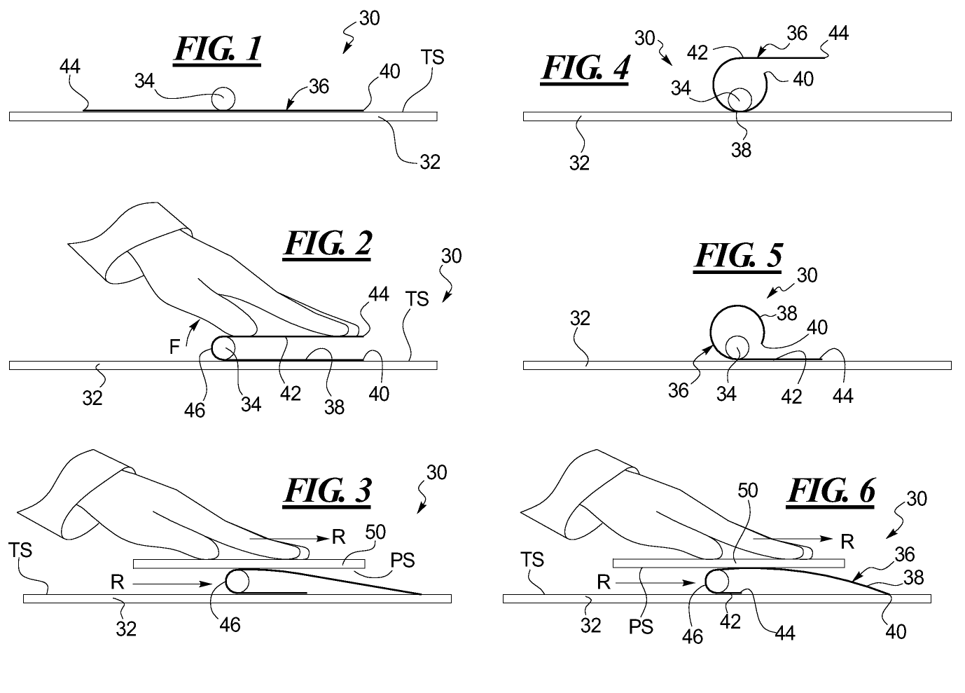

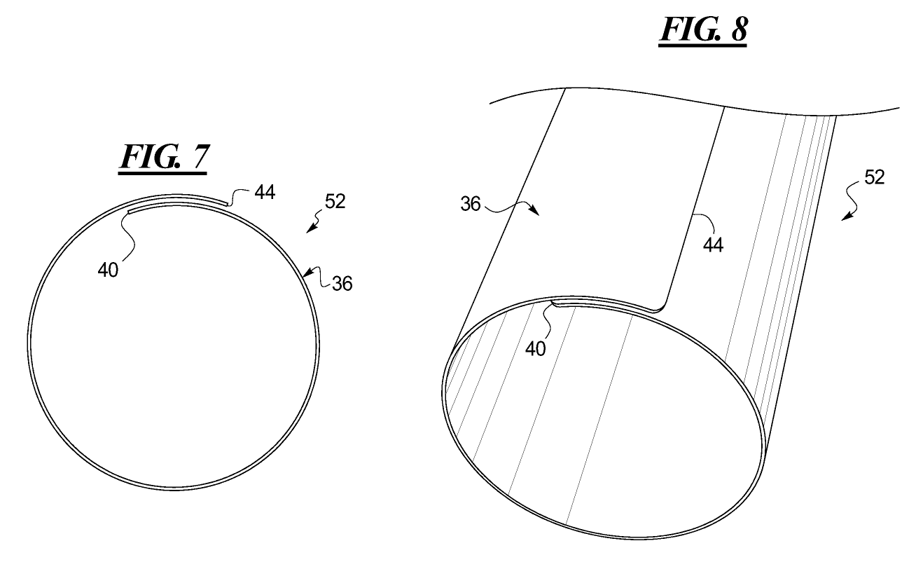

Turning now to the drawings, FIGS. 1-3 show one example of a rolling device 30 constructed in accordance with the teachings of the present invention. FIGS. 1-6 show one example of a process, also in accordance with the teachings of the present invention, for manufacturing a barrel form shown in FIGS. 7 and 8. In this example, the process is depicted as a manual process. As will become evident to those having ordinary skill in the art, the process can be automated partly or completely and accomplished by or within a machine, if desired.

With reference to FIG. 1, the rolling device 30 in this example has, in part, a base plate 32 and an elongate cylindrical mandrel 34 extending widthwise across the base plate 32. The components of the rolling device 30 are shown in side view only, so as to simplify the views and the description of the process. The base plate 32 has a length and a depth or thickness as shown and the mandrel has a diameter as shown. However, the base plate 32 also has a width into the page of the drawing figures though not depicted therein and the mandrel 34 has a length into the page of the drawing figures though also not depicted therein. In this example, the process includes starting with a generally flat sheet 36 of metal having a finite length and width (also into the page though not depicted), as well as a thin profile thickness. The sheet 36 is placed on a generally planar or flat top surface TS of the base plate 32 as shown in FIG. 1. The disclosed process is particularly well-suited for forming a barrel form using an annealed and heat-treated stock material, thus eliminating the need for later heat treating processes and also reducing or eliminating the need for further surface polishing or finishing. However, the disclosed process may also be utilized to form non-heat-treated sheet stock as well.

The next step of the process in this example involves folding the sheet 36 over the mandrel 34 as depicted in FIG. 2 in the direction of the arrow F. When folded, the sheet 36 has one section 38 having a lengthwise end 40 that remains borne against the base plate 32. The sheet 36 has another section 42 that lies above, confronts (at least partially, and is spaced from the one section 38. The other section 42 terminates at an opposite lengthwise end 44 of the sheet 36. The spacing between the two sections 38, 42 in this example is defined essentially by the diameter of the mandrel 34. The two sections 38, 42 of the sheet 36 can also begin generally parallel to one another at the start. As depicted in FIG. 2, the sheet 36 can generally be folded in half, although the sheet need not be folded in half to achieve the desired results, as will become evident to those having ordinary skill in the art upon reading this disclosure. Further, the sheet 36 is folded along a bend 46 that is oriented widthwise across the base plate 32 (into the page of the drawing figure) and thus oriented widthwise across the sheet 36 and relative to the length of the mandrel 34. The bend 46 ultimately conforms to the shape of the mandrel 34 when the sheet 36 is folded and held taught against the mandrel.

The rolling device 30 in this example further includes a press plate 50, which also has a length and a depth as shown in FIG. 3, as well as a width into the page of the figures though also not depicted herein. A pressing surface PS of the press plate 50 is placed on top of the folded sheet 36 over the bend 46 as shown. The press plate 50 is then pressed downward against the mandrel 34. The user can then roll the press plate forward in the direction of the arrow R toward the one lengthwise end 40 of the one section 38 still lying on the top surface TS of the base plate 32. Though not specifically shown in the drawings, the press plate 50 in this example is rolled in the direction of the arrow R until the mandrel reaches the lengthwise end 40, or at least very near the lengthwise end, while continuing to push down on the press plate.

By rolling the press plate 50 as described, the mandrel 34 and, thus, the bend 46 gradually move from the original location of the fold in the sheet 36 to the lengthwise end 40 of the one section 38 of the sheet 36. As shown in FIG. 4, once the mandrel 34 reaches the one lengthwise end 40 on the one section 38 of the sheet 36, the press plate 50 can be removed or released. Once the pressure of the press plate 50 is relieved, the one section 38 of the sheet 36 remains curved or coil-shaped, although to a natural or static diameter that is greater than the diameter of the mandrel 34 for reasons described below. The sheet 36 can then be flipped over, side to side or widthwise, placing the other section 42 on the top surface TS of the base plate 32. The mandrel 34 is then placed between the two sections 38, 42 as shown in FIG. 5.

The press plate 50 can then be replaced on top of the sheet 36 and the mandrel 34. The sheet 36 can then be re-folded so that the mandrel 34 is taught against the surface of the seat 36 re-defining the bend 46. Though not specifically depicted in the drawings, the user can manually assure that the lengthwise end 40 of the elevated one section 38 does not curl under the press plate between the two plates. As shown in FIG. 6, the user can then place their hand on and press the press plate 50 against the mandrel at the bend 46. The user can then roll the mandrel 34 and the sheet 36 in a forward direction, again in the direction of the arrow R. This rolling movement will again gradually move the bend 46 from the original location of the fold in the sheet to the other lengthwise end 44, or very near the other lengthwise end, of the other section 42 on the sheet 36. Once the user has rolled the mandrel 34 from one end 40 of the sheet 36 to the other end 44 of the sheet, the user can release and remove the press plate 50. Upon doing so, the sheet 36 will roll up into a coil shape or barrel form 52 as depicted in FIGS. 7 and 8. The lengthwise ends 40 and 44 can overlap and are not joined to one another.

The above disclosed process will function as long as the size or diameter of the mandrel 34 is chosen so that the sheet is folded beyond or past the yield point of the hard temper, heat-treated sheet stock. Once the sheet 36 is folded beyond its yield point, some deformation will take. By gradually moving the fold 46 from one end of the sheet 36 to the other, the same deformation essentially will take over the entire length of the sheet, resulting in the barrel form 52. The type of metal, the thickness of the sheet stock, and the size of the mandrel will combine to determine the static or relaxed diameter of the barrel form 52 such as that shown in FIGS. 7 and 8.

Since the sheet 36 is already heat-treated, the surfaces can also already be polished and essentially finished and ready for use upon completion of the barrel form shape. In order to protect the surfaces of the sheet 36 during the above-described manual forming process, one or both of the base plate 32 and press plate 50 can be fabricated so as to inhibit or prevent marring, scratching, or abrading of the sheet surfaces. In one example, the base plate 32 and/or the press plate 50 can be made entirely from a substantially rigid material having a nonabrasive, elastomeric, or other non-harmful type surface. In one example, both of the plates 32, 50 can be fabricated from a stiff or rigid material such as a high durometer elastomeric material, hardened or vulcanized rubber, or the like. In another example, one or both of the top surface TS and press surface PS can have an applied elastomeric or other non-harmful coating or layer thereon. In either example, the surfaces coming into contact with the sheet 36 can have non-marring or non-abrasive characteristics so as not to damage the sheet while it is being rolled and formed according to the disclosed processes.

In one example, the sheet 36 can be formed of a material, such as a heat-treated 301, cold-rolled, stainless steel provided in sheet or shim stock form and having a thickness of about 0.003 inches. In alternate examples, other heat-treated metal stock materials can be used, such as aluminum, copper, composites, alloys, and the like. As noted above, it is also not necessary that the material be heat-treated prior to undergoing the rolling processes described herein. The material can be a non-heat-treated material that is instead to be heat-treated and polished or surface finished after the barrel form 52 is fabricated.

Use of a heat-treated sheet stock material for producing the sheets 36 can achieve certain benefits in accordance with the teachings of the present invention. Specifically, heat-treated metal retains a certain amount of elasticity and resiliency. Thus, when the material is formed as described herein into a spiral or coil, i.e., the shape of the barrel form 52, it can be expanded and contracted radially, changing the diameter of the barrel form. When released, the barrel form 52 will return to its relaxed or static size or shape. Thus, the barrel form 52 as disclosed herein is well-suited for use as an adjustable-diameter barrel structure. The extremely simple nature of the above-noted and other processes disclosed herein, as well as the simple and relatively inexpensive components of the rolling device 30 and other rolling devices disclosed herein can produce a barrel form 52 having a very low manufacturing cost and thus a modest piece price. This may be essential when decisions are made whether to produce some relatively low cost or low margin products and implements.

The length of the sheet 36 can be selected based on the desired relaxed or static diameter of the barrel form 52 as well as the desired radial adjustability of the form. The width of the sheet 36 can be selected based on the desired axial length of the barrel form 52, after fabrication, between the open ends of the tube shaped form. For products or implements requiring longer barrels, the width of the sheet 36 can be greater than the sheet of a sheet used to create a barrel for implements requiring a shorter barrel length. Similarly, for implements requiring larger diameters, the length of the sheet 36 can be longer between the lengthwise ends 40, 44. In one example, the sheet 36 can have a length of about 6 inches and a width of about 6 inches, to go with the above-noted thickness of 0.003 inches. In alternative examples, the sheet 36 can be provided having differing lengths, widths, and/or thicknesses, as desired for a particular application.

The base plate 32 as described above can be formed as a durable flat plate structure having a smooth, hard bearing surface as the top surface TS. In one example, the base plate 32 can be provided as a slab of stone, such as granite, with the bearing surface or top surface TS ground or polished to a smooth, flat finish. In another example, the base plate 32 can be provided as a steel plate, an aluminum plate, or the like. In another example, the base plate 32 can be provided having a curve, whether convex or concave, as may be desired for a particular application, instead of being flat as in the disclosed example.

Likewise, the press plate 50 in the disclosed example can be provided as a durable and flat plate whereby the press surface PS is a smooth, hard bearing surface. In one example, the press plate 50 can be formed as a wood panel with a sanded or polished press surface PS. To prevent marring of the surfaces of the sheet 36 and to improve the coefficient of friction between the sheet and the press plate 50, the press plate can be provided with a material layer or coating over the press surface PS from a relatively soft material. Such a layer or surface can minimize any post-forming finishing or polishing steps needed. Such a surface or layer can also reduce or eliminate slipping between the sheet 36 and the press surface PS during rolling. As noted above, a layer of rubber or other elastomeric material can be provided to define the exposed press surface PS. There may be instances where the visible condition of the barrel form 52 is not important to the consumer or not required for a particular application. In such instances, a soft bearing surface or coating on the surface PS need not be included. In another example, the press plate 50 can be provided as a steel plate, with or without an elastomeric or other bearing surface, and particularly in processes that are automated instead of requiring manual operation. In another example, the press plate 50 can also be curved, either convex or concave, as may be desired or necessary for a particular application.

The mandrel 34 in the disclosed example can have a cylindrical bearing surface or outer surface 54. The outer surface 54 of the mandrel 34 can also be a durable, smooth, hard surface. The length of the mandrel 34 should be at least as wide as, and probably wider than, the sheet 36 which is to be bent and folded over the mandrel. In one example, mandrel 34 can be provided as a round or cylindrical shaft made of metal, such as a cold-rolled steel or other rigid material. In an alternate example, the outer surface 54 of the mandrel 34 need not be smooth or hard, but instead can be textured to include a grid pattern, knurling, and/or some other type of indentation. In addition to or instead of the surface 54 of the mandrel 34, the top surface TS of the base plate 32 and/or the press surface PS of the press plate 50 can also include such surface texturing instead of being smooth, if desired or needed for a particular occasion.

The diameter of the mandrel 34 can be selected based on a desired finished diameter of the barrel form 52 when in the relaxed or static state. In one example, the mandrel 34 can have a diameter of about 0.25 inches. When used with 301 cold rolled steel as described above, a mandrel of this size can be utilized to produce a barrel form 52 having an external diameter of about 0.875 inches when in the static or relaxed state. Increasing the diameter of the mandrel 34 increases the diameter of the barrel form 52 produced. Likewise, decreasing the diameter of the mandrel 34 decreases the diameter of the resulting barrel form. The relationship between barrel form diameter and mandrel diameter will depend on a number of factors including the hardness of the selected material for the sheet 36, its material properties, the thickness of the sheet, and the like. Testing has shown that the ratio of the barrel diameter to the mandrel diameter may be about 3.5:1 for the above-noted sheet material and thickness. Thus, in order to produce a barrel form 52 with an outside diameter of about 2.0 inches in the relaxed or static state, the mandrel 34 can be selected having a diameter of about 2.0/3.5 inches, or about 0.57 inches in diameter.

In one example, the diameter of the mandrel 34 and axial length of the sheet 36 between the lengthwise ends 40, 44 can be selected so that the resulting barrel form 52 creates an overlapping structure as shown in FIGS. 7 and 8. In other words, one of the lengthwise ends 40 overlaps with the other of the lengthwise ends 44 when the barrel form 52 is in the relaxed or static state. In such an example, the barrel form 52 can be expanded to increase the diameter from the relaxed or static diameter by application of force. A mechanical or rotational adjustment assembly on a product or implement can be utilized to do so. Because the hard temper material of the barrel form 52 is resilient and flexible, the barrel diameter can expand in such a manner. When the applied force is released, the barrel form 52 will return to its natural or static diameter. The degree to which the diameter of the barrel form 52 can be increased may depend upon the amount of overlap in the barrel form material. Likewise, the diameter of the barrel form 52 can be reduced by application of force or by manipulation of a mechanical adjustment assembly of a product or implement. When the applied force is released, the barrel will return to its natural or static diameter by the resiliency of the material. These adjustable-diameter characteristics will essentially hold true unless the barrel form 52 is deformed radially or diametrically beyond a yield point defined by the various material characteristics.

In a disclosed example, the one section 38 of the sheet 36 first lying against the base plate 32 is gradually bent and rolled around the mandrel 34 before the other section 42. When the sheet metal is flipped, it is the other section 42 that lies against the base plate and gradually bent and folded around the mandrel 34. In this way, the entire sheet 36 can be formed using this simple process. The process of folding the material beyond its yield point around the mandrel 34 essentially folds the material over its entire length to produce the barrel form 52. As noted above, the sheet 36 need not be folded precisely in half. However, folding the sheet in half makes it easier to fold the sheet at the start of the process or during steps of the process.

Once the barrel form 52 is fabricated, there may be a small gap in a radial direction between one end 40 and the other end 44. One simple method to remove this gap is to unwrap the barrel form and exchange the ends such that the end that was on the outside of the barrel form is now on the inside and vice versa. This will remove the radial gap between the exposed ends 40 and 44 of the barrel form 52.

As noted above, the process depicted in FIGS. 1-6 can be performed very simply and inexpensively as a completely manual process. In other examples, one or more simple machines can be provided to automate one or more steps of the process. In one example, a machine can include the base plate 32, the press plate 50, and the mandrel 34 for forming multiple sheets 36 in sequence. The machine may automatically perform one or more of the various process steps noted above, such as placing the sheet 36 on the base plate 32, positioning the mandrel, folding the sheet, applying the press plate, rolling the mandrel, reversing the sheet, releasing the press plate, ejecting the barrel form, and the like. The machine may also require one or more manual steps, such as loading and unloading the sheet and the barrel form, respectively. The machine may also require the manual step of flipping or reversing the orientation of the sheet when only a portion (such as one of the sheet sections) of it has been formed. These steps may also be automated if desired. In another example, such a machine may include a base plate 32 and a press plate 50 arranged at a set distance from one another. Both of the plates can be automatically moved in opposite directions within the machine when rolling the barrel form 52. This may make the process more efficient with less space needed for linear movement of the components.

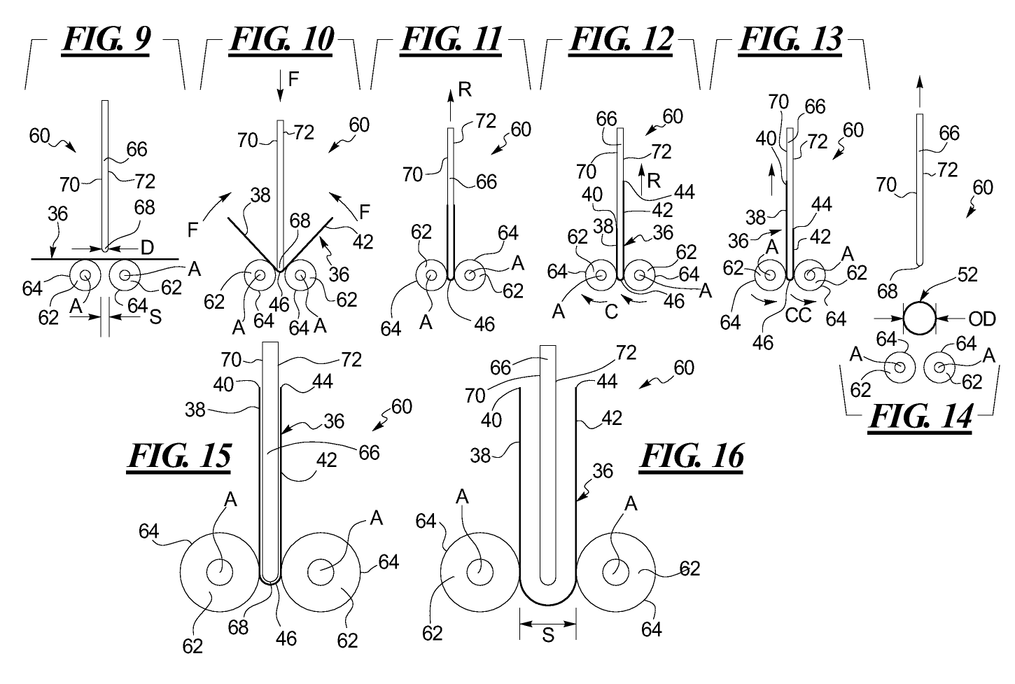

FIGS. 9-14 show another example of a rolling device 60 constructed in accordance with the teachings of the present invention. In this example, the rolling device 60 has a pair of rollers 62, each with an exterior circumferential surface 64. Each of the rollers in this example is an elongate circular cylinder having a length (not shown) into the page of the drawings. The two rollers 62 are spaced apart having a spacing S or gap therebetween. The spacing S defines a nip between the rollers 62. The rolling device 60 in this example also has an arbor plate 66 arranged normal or perpendicular to a plane defined by the rolling axis of the two rollers 62. One end or edge of the arbor plate facing the rollers can be specifically formed to define a mandrel 68 thereon. The arbor plate 66, and thus the mandrel 68, is movable toward and away from the two rollers 62 in this example. The mandrel 68 also has a cylindrical or semi-cylindrical surface with a corresponding diameter D.

The function of the rolling device 60 and the corresponding process utilizing this device to create the barrel form 52 in this example will be described using the same sheet 36 of the prior embodiment. As shown in FIG. 9, the mandrel 68 is spaced upward and away from the two rollers 62 prior to the start of the process. The initially flat sheet 36 can be placed against the outer surfaces 64 of the two rollers 62, thus lying in a plane parallel to the roller axes A. Similar to the previously described process, the sheet 36 can be folded at the fold 46 creating the two sections 38 and 42 of the sheet as shown in FIG. 10. The sheet 36 is folded by moving the arbor plate 66 and mandrel 68 in the direction of the arrow F into contact with the sheet across widthwise direction. The mandrel 68 is moved to a position within the nip between the rollers 62. The rollers will bend the sheet 36, creating the fold as shown in FIG. 10.

When the sheet 36 is completely folded, as shown in FIG. 11, each section 38, 42 of the sheet 36 lies against a respective side 70, 72 of the arbor plate 66. When the arbor plate 66 is in the fully extended position, the sheet 36 is essentially bent to about 180°. However, the fold 46 is shaped to correspond with the curvature of the mandrel 68 on the end of the arbor plate 66 similar to the prior example. Once the sheet 36 is completely folded, the arbor plate 66 can be retracted slightly, such as by about 0.03 inches, in the direction of the arrow R as in FIG. 11. This is because the mandrel 68 in this example functions more to fold the sheet 36. The mandrel 68 is not necessary to roll the sheet from end to end. The barrel form 52 can be created by moving the rollers 62 without any contract between the sheet 36 and the mandrel 68. The degree to which the mandrel 66 is retracted can certainly vary and can be more or less than 0.03 inches.

Once the sheet 36 is folded, the pair of rollers 62 can be rotated in unison in one direction, such as the clockwise direction C as shown in FIG. 12, so as to gradually move the fold 46 in the sheet, similar to the prior example, from about the middle of the sheet to the one lengthwise end 40. When the lengthwise end 40 reaches or nearly reaches contact with the nip of the rollers 62, the one section 38 of the sheet 36 has been completely rolled. As shown in FIG. 13, the direction of rotation of the two rollers 62 can then be reversed and rotated in unison in the counterclockwise direction CC. This will move the sheet 36 in the opposite direction, which in turn gradually moves the fold 46 in the sheet toward the other lengthwise end 44. When the other lengthwise end 44 reaches or nearly reaches of the nip between the two rollers 62, the other section 42 of the sheet 36 has been rolled and formed.

Once the entire length of the sheet 36 has been rolled to or through the nip between the two rollers 62 from the one lengthwise end 42 to the other lengthwise end 44, the mandrel 68 can be retracted from the two rollers 62 as shown in FIG. 14. This in turn releases the sheet 36, which is then free to roll up into the coil shape creating the barrel form 52 as shown in FIGS. 7 and 8. Coiling up of the sheet 36 is prevented during the rolling process by continuous contact of the two sheet sections 38, 42 with the sides 70, 72 of the arbor plate 66. As described earlier, the mandrel 68 has a surface shape with an effective diameter D, whereas the barrel form 52 has a larger outside diameter OD. The completed barrel form 52 can then be removed from the rolling device 60.

As with the rolling device 30, the rolling device 60 can also be configured to be a completely manual operation. The rollers 62 can be geared to one another and a hand crank can be provided to manually rotate the rollers in each direction as needed. Similarly, the arbor plate 66 can be provided with a handle or crank, a rack and pinion gear system, and/or the like to raise and lower or move the mandrel 68 toward and away from the two rollers 62. In another example, one or more of the steps performed by the rolling device 60 can be automated in a machine. For example, the rollers 62 can be coupled to a motor that is actuated automatically. Sensors can be provided to determine a location of the sheet 36 at all times during the process. The sensors can be utilized to determine when rotation of the rollers 62 should be stopped and/or reversed as needed during the process. Similarly, a motor can be provided to move the arbor plate 66 toward and away from the rollers 62 as needed during the process. In another example, a process utilizing the rolling device 60 can also be completely and fully automated and computerized, requiring virtually no user interaction during operation of the machine or during the fabrication process of the barrel forms 52. A continuous strip of stock material can be fed into the machine. Individual sheets 36 can be cut from the strip or each individual barrel form 52 can be cut from the unformed strip after being rolled.

As with the earlier described rolling device 30, the outer surfaces 64 of the rollers 62 and the opposed sides 70, 72 of the arbor plate 66 can include a non-marring surface feature, surface texturing, or the like as desired. Alternatively, one or both of the rollers 62 and/or the arbor plate 66 can be entirely or mostly fabricated from such a non-marring material.

Each of the above-described rolling devices 30 and 60, as well as the processes associated therewith, replace the standard roll forming techniques of applying pressure across one tangent point of a mandrel on a material strip in the lengthwise direction as the strip passes over progressive shaping rollers. Instead, the disclosed rolling devices 30 and 60 induce curvature over a finite width of the sheet material by folding the sheet along the fold 46 and then gradually moving the fold over the length of the sheet. The fold in these examples always deforms the sheet beyond the yield point of the hard temper or heat-treated stock material. The disclosed processes allow for the application of substantially high pressure to the sheet 36 at relatively small diameters, with virtually no deformation across the equipment, and particularly the mandrel.

Any metal sheet stock material will resist deformation up to the yield point. In the case of hardened or hard tempered stainless steel shim stock, it can be nearly impossible to roll form such material using a standard roll forming machine. This is because of its very high yield point. Thus, heat-treating is performed after the material is formed. However, due to the temper of heat-treated stock material, the material can be folded over by pulling one side over the other and applying pressure at the fold. Deformation of the material along the fold beyond its yield point essentially reforms the material. Doing so over a relatively consistent diameter fold results in relatively consistent deformation of the stock material to create the barrel form 52. Thus, the disclosed processes can create a specific and controlled bend or curvature in heat-treated or hard temper stock material. Gradually moving the fold over the entire length of the sheet stock results in folding the stock material at infinite points over its entire length, and thus creating a virtually perfect roll form 52.

Some experimentation was conducted utilizing the rolling device 60 to confirm that various characteristics of the sheet 36 and the process can be varied to yield repeatable desired barrel forms 52 of various diameters. Given a desired barrel outside diameter D, a thickness of the sheet material, the temper of the heat treated sheet, and the roller spacing S can be determined suitable to produce the desired barrel form. Various tests were conducted to produce 1.0 inch outside diameter OD barrel forms. For example, 0.008 inch thick sheets 36 of stainless steel shim stock (301/302/304) with the Rockwell hardness number (C scale) of 40-45 were tested at a variety of different roller spacings S and were ultimately successful. The desired 1.0 inch barrel OD was also obtained by using the rolling device 60 and a sheet thickness of 0.005 inches at a roller spacing S of 0.3125 inches. Other testing was conducted to manufacture barrel forms with outside diameters of 1.25 inches, 0.75 inches, and 0.875 inches using the same stock material, but of different thickness. In various examples, sheets having thicknesses of 0.003 inches, 0.004 inches, and 0.005 inches, were tested with various roller spacing S of 0.3125 inches, 0.25 inches, and 0.1875 inches. The various tests produced a variety of different barrel forms 52 of differing diameters OD. However, each of the barrel forms had an essentially perfect barrel form shape.

To automate the processes described above, conventional mechanisms, linkages, motors, and the like can be utilized. Additionally, electronic equipment and computers can be utilized to fully automate and control the process as desired. Conventional drive mechanisms can include electronic motors, solenoids, pneumatic pistons, hydraulic pistons, air pots, and other such cylinders and devices. Mechanical linkages can also be employed as needed to manipulate the various plates, rollers, and mandrels. Also, since the diameter of the rollers 62 has essentially no effect on the barrel form diameter OD, the roller diameter can be quite large allowing for high strength, durability, and the like for the process and the rolling device 60. Rollers of virtually any size can be controlled in an automated process.

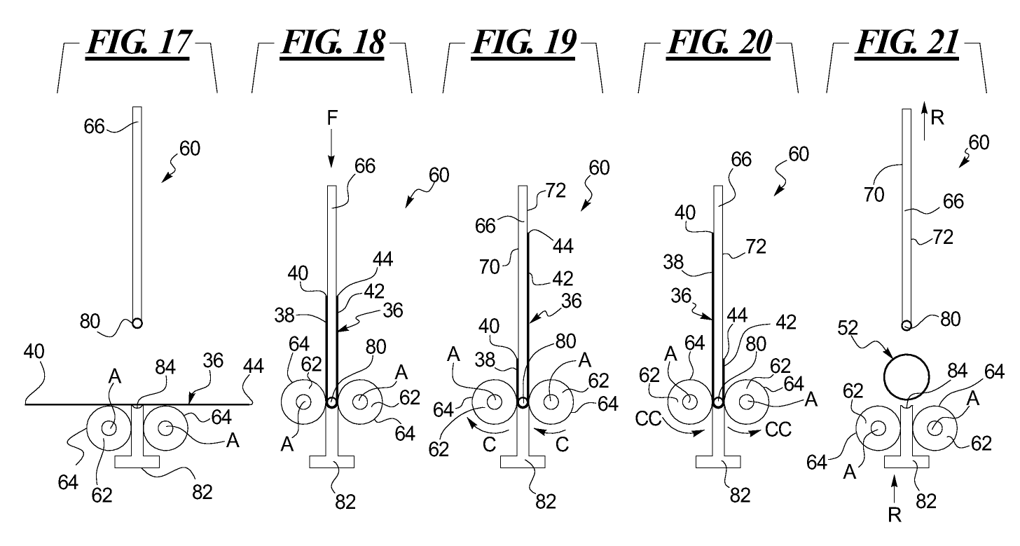

With reference to FIGS. 15 and 16, one optional modification to the rolling device 60 can include roller spacing adjustment. The two rollers 62 can be provided so that the distance between the roller axes A can be adjusted thereby allowing the user to set a desired spacing S between the two rollers. Adjustment of the spacing S allows for different barrel form diameters to be created utilizing the same device 60. Spacing adjustment also allows for different stock materials to be utilized with the same device 60. FIG. 15 shows an enlarged view of the rolling device 60, very similar to that depicted in FIG. 11, whereby the sheet 36 has been folded and is ready to be formed. In this view, the spacing S between the rollers is relatively small leaving very little gap between the sheet 36 and the mandrel 68. FIG. 16 shows the same rolling device 60 whereby the spacing S between the rollers has been adjusted to a larger size after the sheet 36 has been folded. Clearly, the spacing S is much larger than the size of the mandrel 68 in this example. The rollers 62 can still retain the sheet 36 folded between the rollers and the rollers can be rotated in both directions to gradually fold the entire length of the sheet 36. However, the resultant barrel form 52 will have a larger diameter OD utilizing the larger spacing S. As noted above, it is not necessary that the mandrel 68 be in contact with the sheet 36 during rolling of the sheet. Thus, the sheet 36 is shown not to be in direct contact with the mandrel 68 or the armor plate 66 in either of FIGS. 15 and 16.

By providing adjustable spacing between the rollers 62, many different stock metals, shim stock having different thicknesses, the shim stock having different hardness or hard temper characteristics, and the like can be formed utilizing the same rolling device 60 with relative ease. The spacing S between the rollers 62 can be adjusted to accommodate specific material characteristics and to create a barrel form 52 having a desired outside diameter OD. In a rolling device 60 having this roller adjustment option, one of the rollers 62 can be stationary while the other can be adjustable relative to the fixed roller. In another example, both of the rollers 62 can be adjustable relative to one another.

FIGS. 17-21 show further optional modifications to the rolling device 60. In this example, the arbor plate 66 can include a completely cylindrical mandrel 80 that is rollably mounted or attached along one edge of the arbor plate. In the earlier example, the mandrel 68 was provided as a rounded integral surface on the edge of the arbor plate. In this example, the mandrel 80 is a separate component that can rotate relative to the edge of the arbor plate 66. The rolling mandrel 80 in this example can assist in preventing damage to the surfaces of the sheet 36 when the sheet is folded. The rolling mandrel 80 can also allow for slight tolerance variations and movement between the mandrel and sheet 36 when folded without marring the surface of the sheet.

The rolling device 60 in this example also has an optional pressure pad 82. The pressure pad 82 has a contact end 84 configured to help form the fold 46 in the sheet 36 when the arbor plate 66 is lowered between the rollers 62. The contour of the contact end 84 can be configured to match that of the mandrel 80 in this example. The pressure pad 82 can be moved in the direction of the arrow R to a ready position (not shown) that would be below the sheet 36 when laid upon the rollers 62. The pressure pad 82 can be moved from the ready position upward to a fold position as shown in FIGS. 17-20. In the fold position, the pressure pad 82, and particularly the contact end 84, is positioned adjacent the sheet 36 when placed on the rollers 62. The mandrel 80 and arbor plate 66 are lowered into the nip and into contact with the sheet 36 to create the fold 46. The mandrel 80 in this example forces the sheet 36 against the contact end 84 of the pressure pad 82 has shown in FIG. 18. The pressure pad 82 essentially helps to support the sheet 36 during folding and can further be used to precisely position the folded sheet between the rollers 62 prior to and while rolling the sheet.

As shown in FIGS. 18 and 19, the contact end 84 of the pressure pad 82 can also assist in guiding the sheet 36 during folding process as well as maintaining the positioning of the sheet relative to the rollers. Rolling and bending of the sheet 36 in this example is thus cooperatively done by the rollers 62, the pressure pad 82, and the mandrel 80. Though not shown specifically in these figures, the arbor plate 66 and mandrel 80 can be retracted away from the sheet 36 during rolling and bending of the sheet. However, because the mandrel 80 can roll relative to the arbor plate 66, the mandrel may stay in contact with the sheet during rolling and bending, as depicted in FIGS. 18 and 19.

In this example, the pressure pad 82 can also be further extended upward or between the rollers 62 to an ejector position as shown in FIG. 21. Once the sheet 36 has been completely rolled and bent as previously described, the mandrel 66 can be retracted upward in the direction of the arrow R, allowing the sheet 36 to roll up and coil into the barrel form 52. Once the mandrel 66 is out of the way, the pressure pad 82 can be extended between the rollers 62 to eject the barrel form 52 as shown. Again, operation of the pressure pad 82 can also be entirely manual or can be automated in a machine as desired.

In another optional example, though not shown in the drawings, the plane defined by the axes A of the rollers 62 can also be adjustable. Allowing adjustment of the plane of the roller axes A relative to the arbor plate 66 and/or the optional pressure pad 82 can allow for further operational adjustability to accommodate many different stock materials and to manufacture many different desired barrel forms.

As will be evident to those having ordinary skill in the art upon reading this disclosure, many of the various features, components, and options of the disclosed examples can be selectively employed or not employed in other examples and with other of the features, components, and options. The disclosed processes and devices can provide for a much more efficient manufacturing procedure to make coiled or spiraled barrel forms in comparison to using known roll forming machines and techniques. One advantage of using the disclosed processes and devices is that the secondary operations or need for same can be minimized or eliminated while producing a final product barrel form. This is because the barrel form need not be heat treated after being fabricated. As a result, the finished barrel form may require only minimal or even no surface polishing or finishing. This can be particularly true when the non-marring surface features on the device components as described herein our utilized. Another advantage of the disclosed processes and devices is that barrel forms can be created from substantially thin hard tempered materials and rolled into relatively small diameter barrel forms. This can be done with hard tempered, heat-treated shim stock. This cannot typically be done using conventional roll forming machines and methods.

The disclosed processes and devices can also be utilized to manufacture both adjustable-diameter barrel forms and fixed-diameter arrow forms. Once the barrel form 52 is created utilizing the disclosed processes, the lengthwise ends 40, 44 can be joined to one another using any suitable means. In one example, the free ends of the barrel form can be welded to one another in order to create a fixed-diameter product. The amount of overlap or coiling of the barrel form 52 as disclosed herein can also vary considerably according to the needs of a particular application. The form can have only a minimal overlap as shown in FIGS. 7 and 8, or even less or no overlap, if desired. The barrel form 52 can also have much more overlap or even multiple windings in the coil shape, depending on the length of the sheet 36, the material selected, the size of the bend, and the like.

In one particular example, the barrel form 52 is well suited for use in hairstyling products having hair curling barrels. Examples of same include curling irons with adjustable-diameter barrels, such as those disclosed in co-pending U.S. application Ser. Nos. 12/880,427 and 12/975,541, each entitled “Adjustable-Barrel Curling Iron.” Each of these applications is assigned to the assignee of the present invention and each is hereby incorporated by reference herein in their entirety. Each of these applications discloses one or more curling irons with hair curling barrels that utilize an adjustable barrel form such as the barrel form 52 disclosed herein. The hair curling barrel in each of these applications is connected to an adjustment mechanism that can rotate one free end of the barrel around the other fixed end to increase or decrease the barrel diameter. As noted above, however, the barrel form 52 and disclosed manufacturing processes and devices are equally well suited to fabricate barrel forms for many other applications, products, and implements.

Although certain barrel forms and barrel forming processes and devices have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A process of making an adjustable diameter barrel form, the process comprising the steps of:
providing a sheet formed of metal;
positioning one side of the sheet against two rollers that are spaced apart and positioning a mandrel of an arbor plate spaced from the other side of the sheet;
folding the sheet by moving the mandrel of the arbor plate into contact with the sheet and between the two rollers;
rotating the two rollers so as to bend the sheet over substantially the entire length of the sheet; and
retracting the arbor plate and mandrel releasing the sheet to roll up in a lengthwise direction into a coil.

2. A process according to claim 1, wherein the step of providing includes providing a heat-treated metal sheet.

3. A process according to claim 1, further comprising the step of adjusting a spacing between the two rollers to achieve a desired roll form diameter of the coil.

4. A process according to claim 1, wherein the step of rotating includes rotating the two rollers in unison.

5. A process according to claim 1, wherein the step of rotating includes rotating the two rollers in one direction until one lengthwise end of the sheet nears or reaches the mandrel and then rotating the two rollers in the opposite direction until the other lengthwise end of the sheet nears or reaches the mandrel.

6. A process according to claim 1, wherein one or more of the steps of positioning, folding, rotating, and retracting are performed manually.

7. A process according to claim 1, wherein one or more of the steps of positioning, folding, rotating, and retracting are performed in an automated machine.

8. A process according to claim 1, wherein the step of positioning includes positioning the sheet against two rollers that are formed of or that have an outer surface formed of an elastomeric material that inhibits marring surfaces of the sheet but increases friction between the outer surfaces of the two rollers and the sheet.

9. A process according to claim 1, further comprising the step of locating a pressure pad opposing the arbor and mandrel between the two rollers.

10. A barrel form product produced by a process according to claim 1.

11. A process of making an adjustable diameter barrel form, the process comprising the steps of:
providing a sheet formed of metal;
positioning one side of the sheet flat against a base plate;
placing a mandrel across a width of the sheet;
folding the sheet over the mandrel, exposing a portion of the one side;
applying pressure against the exposed portion of the one side along the fold using a press plate forcing the mandrel and sheet toward the base plate;
moving the press plate parallel to the base plate, rolling the mandrel from one lengthwise end of the sheet to the other; and
removing the press plate and mandrel releasing the sheet to roll up in a lengthwise direction into a coil.

12. A process according to claim 11, wherein the step of moving includes manually moving the press plate.

13. A process according to claim 11, wherein the step of moving includes moving the press plate in one direction until one lengthwise end of the sheet nears or reaches the mandrel and moving the press plate until the other lengthwise end of the sheet nears or reaches the mandrel.

14. A process according to claim 11, wherein the step of moving includes moving the press plate in one direction until one lengthwise end of the sheet nears or reaches the mandrel, flipping the mandrel and sheet over, and moving the press plate in the same one direction until the other lengthwise end of the sheet nears or reaches the mandrel.

15. A process according to claim 11, wherein one or more of the steps of positioning, placing, folding, applying, moving, and removing are performed manually.

16. A process according to claim 11, wherein one or more of the steps of positioning, placing, folding, applying, moving, and removing are performed in an automated machine.

17. A process according to claim 11, wherein the step of applying pressure includes using one side of the press plate having an outer surface formed of an elastomeric material that inhibits marring surfaces of the sheet but increases friction between the outer surface of the press plate and the sheet.

18. A barrel form product produced by a process according to claim 11.

19. A process of making an adjustable diameter barrel form, the process comprising the steps of:
providing a sheet formed of annealed and heat treated metal;
folding the sheet along a widthwise bend;
applying pressure to the sheet along the fold within a rolling device;
rolling the sheet within the rolling device over its length gradually moving the bend from one lengthwise end to the other lengthwise end while applying the pressure; and
removing the pressure releasing the sheet to roll up in a lengthwise direction into a coil.

20. A process according to claim 19, wherein the step of folding includes folding the sheet through contact with a mandrel.

21. A process according to claim 19, wherein the step of folding includes placing the sheet against a spaced apart pair of rollers and moving a mandrel of an arbor plate against the sheet and between the pair of rollers, wherein the step of applying pressure is conducted between the rollers, and wherein the step of rolling includes rotating the pair of rollers in unison.

22. A process according to claim 19, wherein the step of folding includes placing the sheet against a base plate and folding the sheet over a mandrel, wherein the step of applying pressure is conducted forcing a press plate against the mandrel and base plate, and wherein the step of rolling includes moving the press plate parallel to the base plate to roll the mandrel and move the bend.

23. A barrel form product produced by a process according to claim 19.
